(19) United States
(12) Patent Application Publication
(10) Pub. No.: US 2013/0218397 A1
(43) Pub. Date: Aug. 22, 2013

(54) METHOD AND SYSTEM FOR CONTROLLING A SELF-PROPELLED ROBOT DEVICE

(71) Applicants: Alberto Griffini, Pontiloro (CR) (IT); Ettore Gaiani, Milano (IT)

(72) Inventors: Alberto Griffini, Pontiloro (CR) (IT); Ettore Gaiani, Milano (IT)

(73) Assignee: ACTIVE S.R.L., San Giovanni In Croce (IT)

(21) Appl. No.: 13/811,954

(22) PCT Filed: Jul. 22, 2011
(86) PCT No.: PCT/IB2011/053274

§ 371 Date: May 7, 2013

(30) Foreign Application Priority Data
Jul. 28, 2010 (IT) TO2010A000653

(51) Int. Cl. G05D 1/02; A01D 34/00

(52) U.S. Cl. CPC G05D 1/0278; G05D 1/027; A01D 34/008
USPC 701/26; 701/501

(57) ABSTRACT

The present invention relates to a method for controlling a self-propelled robot device, such as a robot device for mowing grass, and a control system that carries out the aforementioned method. According to the invention, the self-propelled robot device is driven by an inertial navigation system for a set time period or distance and the device is periodically stopped for rectifying the position and advancing course thereof by a satellite detection system: the periodic correction of the inertial navigation system using satellite detections thus prevents course errors from accumulating. The correction based on the satellite detection system can be possibly optimized through a further selection of the obtained values according to a statistical basis. Preferably, the control method according to the invention also provides a procedure for detecting, recording and mapping the operating region wherein the device is operated.

### TECHNICAL FIELD

The present invention relates to a method for controlling a self-propelled robot device, such as a robot device for mowing grass or a robot device for performing household cleaning.

The present invention also relates to a control system carrying out the aforementioned method.

### PRIOR ART

Self-propelled robot devices capable of mowing grass of a lawn or cleaning the floors in a building are currently known and available on the market.

The simplest of these robot devices have a rudimentary control system and randomly roam within a confined space.

Obviously, the performances of these robot devices are poor, whereby they can not be used for complex tasks.

For example, in the case of robot devices for mowing grass, devices with such a rudimentary control system can not be used for applications in areas with a complex perimeter, including portions on which the device should not intervene (e.g., paths, flowerbeds and the like).

Self-propelled robot devices are known which have a more sophisticated control system, which provides for the use of complex sensors, such as wireless sensors, proximity sensors, infrared and/or radio-frequency sensors, and so on.

However, the use of devices incorporating such a control system involves the need for careful preparation of the working surface, thus making any subsequent changes complex and expensive.

Moreover, the performances of these devices have proved unsatisfactory, particularly in terms of swiftness in completing the intended tasks and corresponding energy consumption (fuel or electric power).

In more recent times, satellite control systems and inertial control systems have been proposed for this type of self-propelled robot devices.

Even such devices, however, are not free from drawbacks.

Purely satellite control systems, using for example a GPS (Global Positioning System), even if they allow to obtain an absolute position of the self-propelled robot device, lose precision when used in small spaces, such as buildings and small gardens.

In addition, high-precision GPS are available on the market but they are very expensive, which makes them incompatible with applications to small robot devices, such as devices for mowing grass or performing household cleaning.

Purely inertial control systems, using e.g. odometers, gyroscopes, accelerometers and similar instruments, do not allow error compensation, whereby errors tend to accumulate during operation of the self-propelled robot device.

In Eric Abbott, David Powell: “Land Vehicles using GPS,” Proceedings of the IEEE, vol. 87, No. 1, January 1999, pp. 145 to 162, the authors mention the possibility of using an inertial control system to support a satellite control system; however, according to this disclosure the inertial control system would be intended to be used only for short periods when the satellite signal is not available.

The object of the present invention is to overcome the drawbacks of prior art by providing a method and a system for controlling self-propelled robot devices that allows to drive said robot devices in a simple and reliable but still highly accurate way, and also along complex paths.

This and other objects are achieved by a method and a system for controlling self-propelled robot devices as claimed in the appended claims.

### DISCLOSURE OF THE INVENTION

Thanks to the fact that the control method and control system according to the invention combine the advantages arising from the inertial control of the self-propelled robot device and those arising from the satellite control of the same, it is possible to control said device with high precision and reliability.

According to the invention, the control method involves the iteration of a loop comprising the following steps:
the self-propelled robot device is driven by an inertial navigation system for a set time period or a set distance and data relating to the position and path of the device are continuously or periodically recorded;
the device is stopped;
the absolute position of the device is determined thanks to a satellite detection system;
the presumed position, as calculated and recorded by the inertial navigation system, is compared with the absolute position, as detected with good approximation by the satellite detection system;
using an adequate algorithm, the deviation from the course is determined and compensated;
upon correction according to the compensation calculated above, the device is driven again by said inertial navigation system.

Therefore, contrary to what is suggested by Abbott and Powell, according to the invention the self-propelled robot device is mainly driven by an inertial navigation system and the satellite detection system is used only occasionally and on the spot for purpose of correction.

The periodic correction of the inertial navigation system by means of satellite detections thus prevents the course error from accumulating.

The inertial navigation system may comprise one or more instruments selected in the group comprising: an odometer for measuring the travelled distance; one or more gyroscopes; one or more accelerometers; an electronic compass.

The satellite detection system for the compensation of course errors may comprise a DGPS (Differential Global Positioning System).

According to the invention the correction algorithm may advantageously comprise the following steps:
detecting and recording a plurality of parameters relating to the course of the self-propelled robot device during its movement;
comparing the values of the recorded parameters with the values of said parameters at the previous detection and correction step;
assigning to each parameter an index of probability that the recorded data is correct based on a principle of consistency with previous detections;
selecting the parameters with a probability index below a set threshold and removing the parameters with a probability index higher than said threshold;
detecting the absolute position by means of the satellite detection system and calculating the error, and possibly
calculating the maximum distance that can be travelled before stopping the device for the next error compensation.

Advantageously, according to a preferred embodiment of the invention, a procedure for detecting, recording and mapping the operating region is carried out before starting the effective operation of the self-propelled robot device, wherein said procedure comprises the steps of:
placing the device at the starting point and recording the parameters relating to the position of the device itself;
driving the device along the perimeter of the operating region starting from said starting point and coming back again to said starting point, while detecting and recording the parameters relating to said perimeter using the instruments of the inertial navigation system and/or of the satellite detection system;
on the basis of the data collected and recorded data, calculating the complex polygon that determines the perimeter of the operating region;
describing said complex polygon by a vector representation.

Furthermore, always according to a preferred embodiment of the invention, the area of the operating region is subdivided into an array of cells of desired size and each cell is associated with the corresponding data relating to the parameters obtained by the instruments of the inertial navigation system and/or of the satellite detection system, with particular reference to the presence of obstacles and—in the case of outdoor applications—the ground conformation.

Alternatively, the steps of mapping and, in case, subdividing into cells can be carried out by an external device (e.g., a computer) and transmitted from said device to the self-propelled robot device.

### BRIEF DESCRIPTION OF THE DRAWINGS

Additional features and advantages of the invention will be more evident to the person skilled in the art from the detailed description of a preferred embodiment of the invention, given by way of non-limiting example with reference to the attached Figures wherein:

FIG. 1 is a schematic representation of a self-propelled robot device incorporating a control system according to the invention;

FIG. 2 is a block diagram schematically illustrating the control system according to the invention;

FIG. 3 is a flow chart schematically illustrating the main steps of the control method according to the invention;

FIG. 4 is a flow chart schematically illustrating the main steps of the correction algorithm of the control method according to a preferred embodiment of the invention;

FIG. 5 schematically shows the operating region of the self-propelled robot device of FIG. 1;

FIG. 6 is a flow chart schematically illustrating the main steps of the operating region mapping operations according to the control method according to the invention.

### DETAILED DESCRIPTION OF A PREFERRED EMBODIMENT OF THE INVENTION

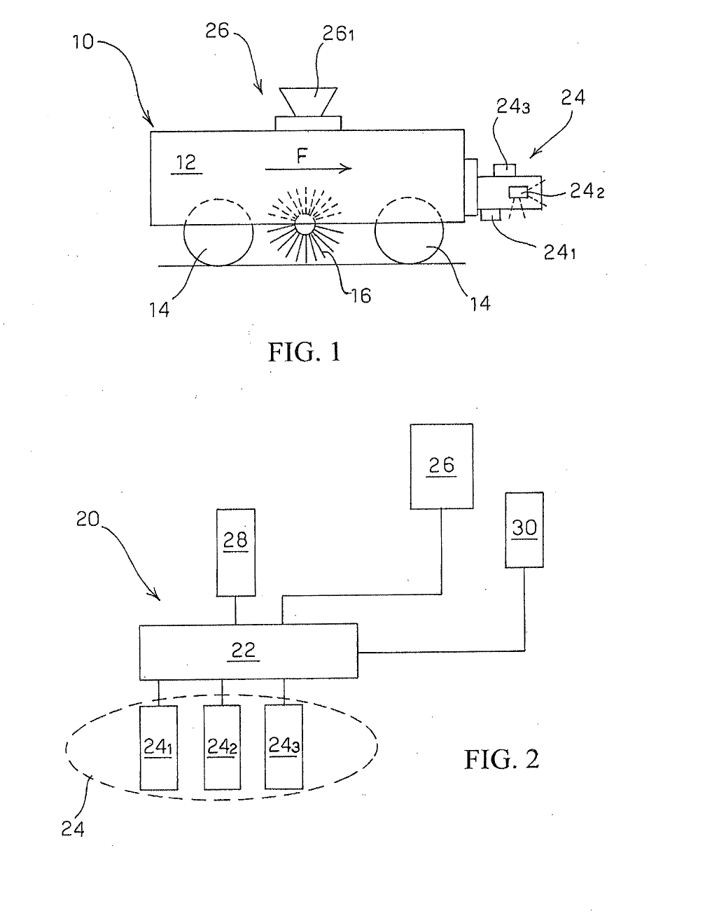

With reference to FIGS. 1 and 2, a self-propelled robot device, namely a lawn-mowing robot device 10, is schematically illustrated.

It is to be noted that although the following detailed description is given with reference to a lawn-mowing robot device 10, the invention can also be incorporated in any other self-propelled robot device (such as a vacuum cleaning device).

The lawn-mowing device 10 includes a housing 12 mounted on wheels 14 for moving in the advancing direction F and is provided with blades 16 or other means for mowing grass and other vegetation.

The lawn-mowing device 10 is preferably driven by an electric motor (not shown) powered by batteries (also not shown) mounted on board.

According to the invention, the lawn-mowing device 10 is provided with a control system 20 that includes at least:
a central computing and controlling unit 22;
an inertial navigation system 24, comprising one or more inertial sensors 24₁,24₂,24₃;
a satellite detection system 26, comprising a detector 26₁ for detecting the absolute position of the device 10;
one or more memory devices 28;
   whereby said control system 20 controls the advancing of said device 10 on the basis of the data relating to the operating region stored in the memory devices 28 (as will be explained in more detail below) and on the basis of the data obtained by the sensors of the inertial navigation system 24 and processed by the central unit 2 and whereby said control system 20 also periodically controls the standstill of the device 10, the detection of the data relating to the position of the device obtained by the satellite detection system 26 and the correction of the position and advancing course as determined from data obtained by said sensors of said inertial navigation system 24 by means of the data obtained from said satellite detection system 26.

More particularly, the inertial navigation system 24 may include one or more sensors selected from the group consisting of: odometers, gyroscopes, accelerometers, compasses. However, any inertial navigation instrument may be used, wherein “inertial navigation instrument” means any electrical, mechanical or electro-mechanical equipment capable of determining and recording the position and advancing course of the device 10 without the need for external references.

The satellite detection system 26 preferably includes a GPS detector or, even more preferably, a DGPS detector. However, any satellite detector can be used, wherein “satellite detector” means any detector capable of determining with good approximation the absolute position of the device 10 by analyzing the signal coming from a satellite.

The memory devices 28 allow to store data relating to the operating region. These data can be inputted by the user or they can be automatically obtained by the control system of the device 10, as will be described below.

In addition, the data obtained from the inertial navigation system 24 and/or the satellite detection system 26 during operation of the device 10 can advantageously be stored in the memory devices 28.

The control system 20 advantageously further comprises a proximity sensor (such as an infrared sensor or ultrasonic sensor) suitable for detecting the presence of obstacles (trees, rocks, flowerbeds) and their position within the operating region of the device 10.

The control system 20 may also include an interface 30 for communicating with the user, wherein said interface 30 can include, for example:
a keyboard for direct entry of data by the user;
a wired (e.g. USB) or wireless receiver for data acquisition by an external device such as a computer;
a screen for displaying the operating parameters of the device 10.

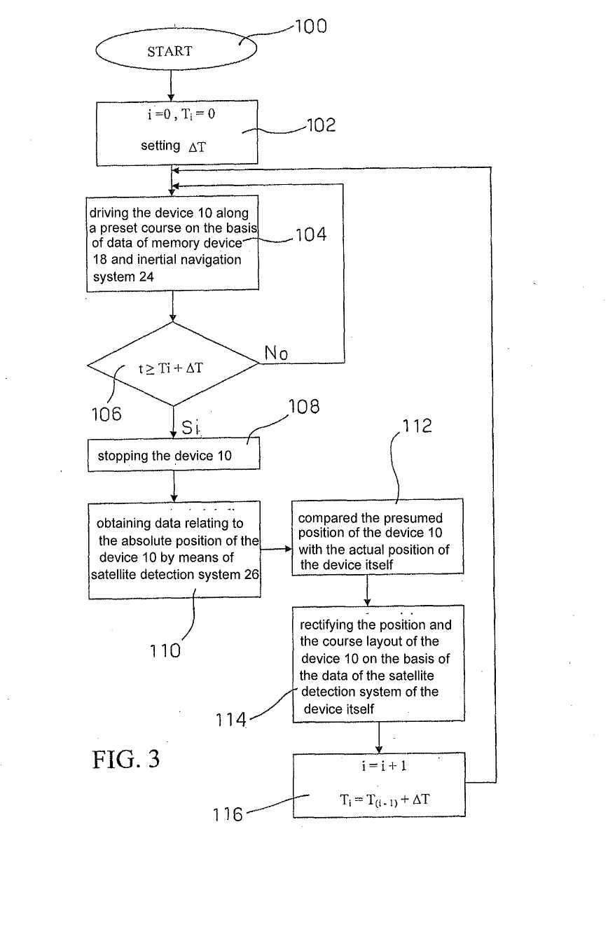

FIG. 3 shows a flow chart schematically representing the control method according to the invention, according to which the control system 20 is operated:
at step 100, the control loop is started; at step 102, the flag i is set equal to 0, the initial time is set equal to 0 and an appropriate time period Δt is set;
at step 104, the lawn-mowing device 10 is driven according to the data relating to the operating region and stored in the memory devices 28 and according to the data obtained by the sensors of the inertial navigation system 24 and processed by the central 22; this steps continues until the time period set above has lapsed (control step 106);
once said time period has lapsed, at stage 108, the device 10 is stopped;
at step 110, the absolute position of the lawn-mowing device 10 is determined by the satellite detection system 26;
at step 112, the presumed position of the device 10 as derivable from the data of the inertial navigation system 24 is compared with the absolute position of said device as obtained by the satellite detection system 26;
at step 114, the central computing and controlling unit rectifies the position and the course layout of the device 10 according to the aforementioned comparison and corresponding error;
at step 116, the flag i is increased, the device 10 is set in motion again and a new control loop is started.

Advantageously, according to the invention at step 110 of determining the absolute position by means of the satellite detection system 26 the device 10 is kept standstill in order to collect a sufficient number of reference points and thus obtaining a good approximation of the absolute position of the device 10. This is possible because according to the invention the satellite detection system 26 is not used to drive the device 10 but it only intervenes on the spot for purpose of correction.

Advantageously, by operating the control system according to the invention in accordance with the control method according to the invention it is possible to prevent the error accumulation that would inevitably occur when using a purely inertial navigation system.

With particular reference to the course correction step,

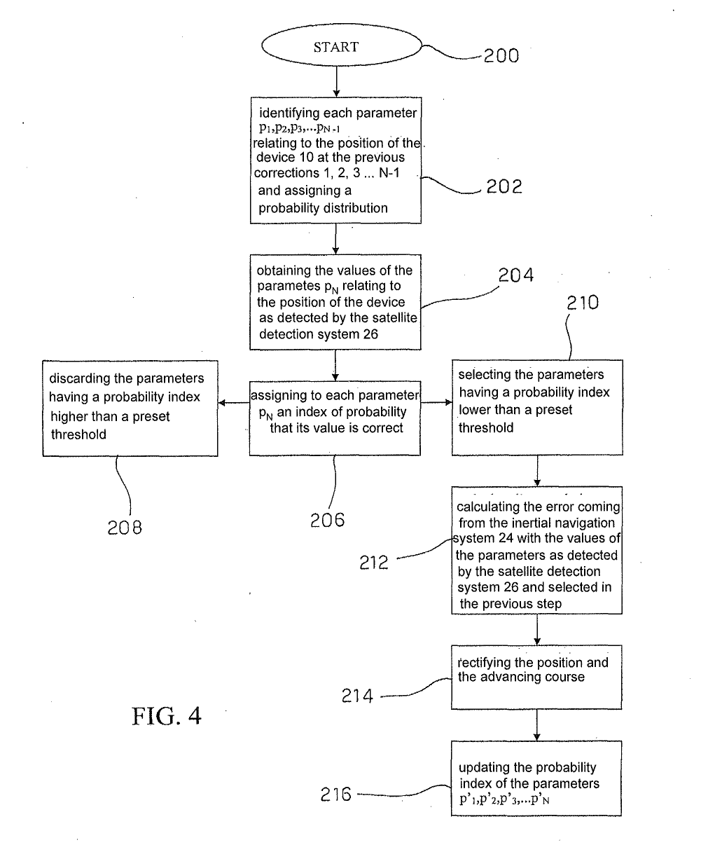

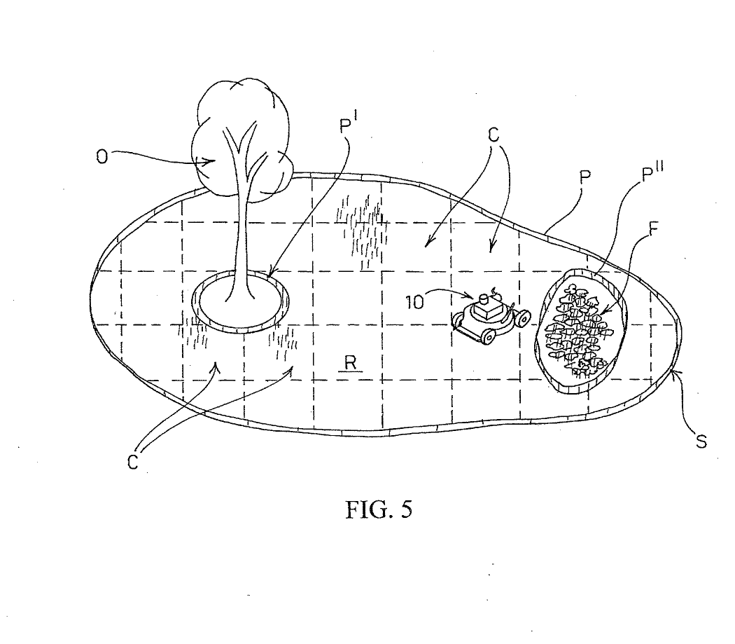

FIG. 4 shows a flow chart that schematically represents a correction method according to a preferred embodiment of the invention.

According to this embodiment, if the correction made by the satellite detection system 26 is not sufficient, it can be integrated with an additional statistical correction routine.

Said statistical correction routine mainly comprises the following steps:
at step 200, the correction loop is started;
at step 202, a plurality of parameters p₁, p₂, p₃, . . . p_{N-1} relating to the position of the device 10 at each of the positions 1, 2, 3 . . . N−1 at which the previous corrections have been made are identified and a probability distribution is assigned to each of said parameters;
at step 204, the values of said parameters p_{N} at the position of the current correction as obtained by the instruments of the satellite detection system 26 and stored in the memory devices 28 are obtained;
at step 206, an index of the probability that the corresponding value is correct is assigned to each of said values of these parameters p_{N} and said probability index is compared with a set threshold; the probability index of each parameter is affected by the distribution probability and by the errors determined during the previous control loops 1, 2, 3 . . . N−1;
at step 208, if the probability index is higher than said threshold, the value of the corresponding parameter is discarded and it will not be taken into account in successive correction loops;
at step 210, the values of the parameters having a probability index lower than said threshold are selected;
at step 212, the error accumulated by the inertial navigation system 24 is calculated according to the values obtained by the satellite detection system 26 and further selected on a statistical basis and, at step 214, the position and advancing course of the device 10 are corrected accordingly;
at step 216, the probability indexes of the parameters are updated according to the calculated errors.

Advantageously, selecting parameters having the highest probability to have a correct value allows to make the correction more effective and reliable.

More particularly, thanks to this expedient the time period ΔT between subsequent corrections can be increased, thus limiting the periods while the device 10 is standstill and, as a result, reducing the overall time for carrying out the tasks set by the user.

Turning now to FIG. 5, it is clear from the above disclosure that before starting the lawn-mowing operations, the data relating to the characteristics of the operating region R, with particular reference to the outer perimeter P of said region R, to the presence of obstacles O, to the presence of areas in which the mowing operation is to be suspended (for example at flowerbeds F) should be inputted in the memory 28 of the control system 20 of the lawn-mowing device 10; in addition, further data relating to slope, unevenness and other characteristics of the ground at different locations of the operating region R can also be inputted.

Said data can be manually inputted by the user, for example through the interface 30 of the control system 20.

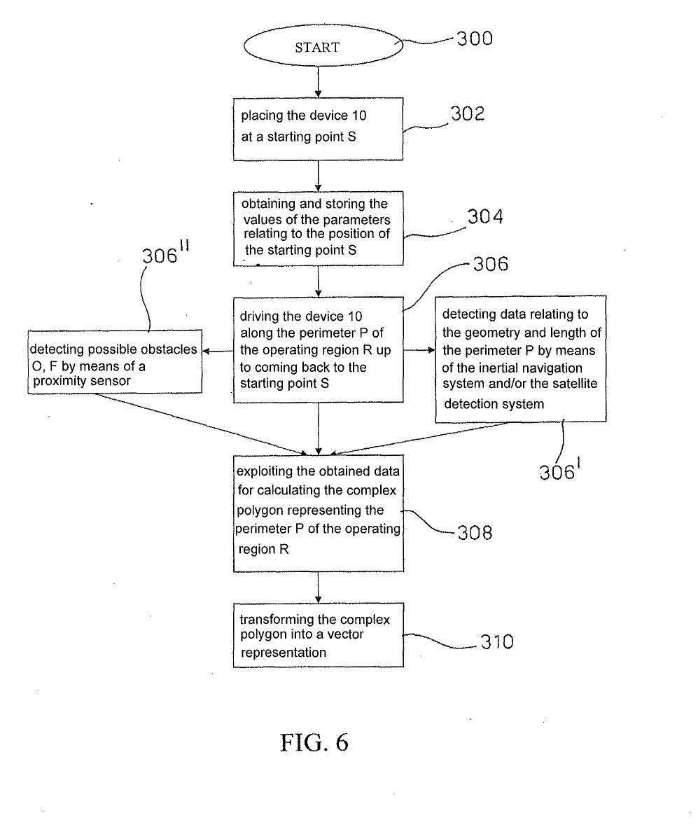

However, with reference to a preferred embodiment of the invention, the control method according to the invention includes a preliminary procedure for obtaining data relating to the boundaries of the operating region; FIG. 6 shows a flowchart representing said preliminary procedure, which involves the following steps:
at step 300, starting the procedure;
at step 302, placing the device 10 at a starting point S, preferably situated along the perimeter P of the operating region R; for example, said starting point may be provided at the station for charging the batteries of the device 10;
at step 304, while the device 10 is standstill at the starting point S, obtaining and recording the values of the parameters relating to the position of said starting point S;
at step 306, driving the device 10 along the perimeter of the operating up to coming back to the starting point S and, at the same time, detecting by the inertial navigation system 24 and/or the satellite detection system 26 the data relating to the shape and extension of said perimeter P (step 306′), as well as detecting by means of a proximity sensor (e.g. an infrared sensor or ultrasonic sensor) the presence and location of any obstacles O, F and the perimeter P′, P″ of the surrounding area (step 306″);
at step 308, using the data obtained in the previous steps for calculating the complex polygon representing the boundaries of the operating region;
at step 310, transforming said complex polygon into a suitable vector representation, for example in Cartesian coordinates.

As mentioned above, the data obtained in the steps 306-306′-306″ mainly concern the position of the device 10 as it moves along the perimeter P of the operating region R, in order to calculate the complex polygon representing said perimeter.

However, preferably additional data are obtained, concerning for instance the ground conformation, the availability of satellite signals, the latitude, longitude and absolute height, and so on.

Returning now to FIG. 5, the preliminary procedure of the control method according to the invention, where appropriate, may provide, instead of a simple detection of the boundaries of the operating region R, an actual mapping of said region R. In other words, the operating region R is subdivided into an array pattern comprising a plurality of cells C of the desired size and for each of said cells C the data relating to the location and characteristics of said cell are obtained and recorded.

Alternatively to the disclosure with reference to FIGS. 5 and 6, the operations of mapping and possibly subdividing into cells can be carried out by an external device (e.g., a computer) and transmitted from said device to the self-propelled robot device using a suitable interface.

It is evident from the above disclosure that the control method and the control system according to the invention achieve the object set forth above and allow to reliably and accurately drive a self-propelled robot device.

It is also evident that the above disclosure has been given by way of non-limiting example and that several modifications and variations are possible without departing the scope of protection of the invention, as defined by the appended claims.

In particular, although the above-described embodiment refers to a self-propelled robot device for mowing grass, the invention can be applied to a self-propelled robot device designed for any function, such as for instance:
sucking solids and liquids;
washing or cleaning the underlying surface;
spreading liquids or gases (such as fertilizers, pesticides, herbicides);
spreading solid products (e.g. seeds);
monitoring the operating region (e.g. by means of a camera);
   and so on.

1.-15. (canceled)

16. A method for controlling a self-propelled robot device, comprising the steps of:
obtaining and storing data relating to the operating region of the self-propelled robot device;
driving the self-propelled robot device according to the data relating to the operating region and to data obtained by an inertial navigation system;
wherein the method further comprises the steps of:
setting a predetermined control time period;
periodically stopping the device when the time period has lapsed;
as the self-propelled robot device is standstill, determining on the spot the absolute position of the device by means of a satellite detection system;
comparing the presumed position of the self-propelled robot device as deriving from the data of the inertial navigation system with the absolute position of the device as determined by the satellite detection system;
rectifying the position and the course layout of the self-propelled robot device, according to the results of the comparison;
setting in motion again the self-propelled robot device according to the rectified data.

17. The method according to claim 16, wherein the rectifying step comprises a further statistical rectifying routine including the following steps:
identifying a plurality of parameters relating to the position of the device at each of the positions at which the previous corrections have been made and assigning to each of the parameters a probability distribution;
obtaining the values of the parameters as obtained and stored by the satellite detection system;
assigning to each of the values of the parameters an index of the probability that the corresponding value is correct;
setting a predetermined threshold for the probability index;
discarding the parameters having a probability index higher than the threshold;
selecting the parameters having a probability index lower than the threshold;
calculating the error accumulated by the inertial navigation system according to the values of the parameters obtained by the satellite detection system and further selected on statistical basis in the previous steps and rectifying the position and the advancing course of the self-propelled robot device;
updating the probability index of the selected parameters.

18. The method according to claim 17, wherein the control time period is not fixed, but it is modified according to the error between the values obtained by the inertial navigation system and the values obtained by the satellite detection system.

19. The method according to claim 16, wherein the control time period is not fixed, but it is modified according to the error between the values obtained by the inertial navigation system and the values obtained by the satellite detection system.

20. The method according to claim 16, wherein the data relating to the operating region are manually inputted by the user.

21. The method according to claim 16, further comprising a preliminary procedure for obtaining the data relating to the boundaries of the operating region, the preliminary procedure comprising the steps of:
placing the self-propelled robot device at a starting point, preferably provided on the perimeter of the operating region;
obtaining and storing the values of the parameters relating to the position of the starting point;
driving the self-propelled robot device along the perimeter of the operating region up to coming back to the starting point; and in the same time
detecting by the inertial navigation system and/or by the satellite detection system the data relating to the geometry and length of the perimeter; and in the same time
detecting by a proximity sensor the presence and position of possible obstacles within the operating region and the perimeter of the surrounding area;
exploiting the obtained data for calculating the complex polygon representing the boundaries of the operating region;
transforming the complex polygon in a suitable vector representation.

22. The method according to claim 21, wherein during the preliminary procedure additional data are further obtained, the data relating for instance to the conformation of the ground, such as slope and unevenness of the ground.

23. The method according to claim 21, wherein the preliminary procedure comprises the step of:
dividing the operating region in a plurality of cells; and
obtaining, storing and associating to each of the cells the data relating to the position and the features of the cell.

24. A system for controlling a self-propelled robot device, comprising at least:
a central computing and controlling unit;
an inertial navigation system, comprising one or more inertial sensors;
a satellite detection system, comprising a satellite detector;
one or more memory devices;
the control system controlling the advancing of the self-propelled robot device according to the data relating to the operating region of the device and stored in the memory devices and to data obtained by the inertial navigation system, the control system further periodically controlling the standstill of the device, the acquisition on the spot of data relating to the position of the device by the satellite detection system and the correction of the position and advancing course of the device according to the data obtained by the satellite detection system.

25. The system according to claim 24, wherein the central computing and controlling unit further comprises an algorithm for selecting on a statistical basis the data obtained by the satellite detection system according to the data previously obtained by the satellite detection system.

26. The system according to claim 24, wherein the inertial navigation system comprises one or more among the sensors selected in the group comprising: odometers, gyroscopes, accelerometers, compasses.

27. The system according to claim 24, wherein the satellite detection system comprises a GPS detector or a DGPS detector.

28. The system according to claim 24, further comprising a proximity sensor suitable for detecting the presence of obstacles and the position thereof within the operating region of the self-propelled robot device,

29. The system according to claim 24, further comprising an interface for communicating with the user, the interface comprising a keypad for the manual inputting of data in the system and/or a receiver for obtaining data from an external device and/or a screen for displaying the operating parameters of the self-propelled robot device,

30. A self-propelled robot device comprising a control system comprising at least:
a central computing and controlling unit;
an inertial navigation system, comprising one or more inertial sensors;
a satellite detection system, comprising a satellite detector;
one or more memory devices;
the control system controlling the advancing of the self-propelled robot device according to the data relating to the operating region of the device and stored in the memory devices and to data obtained by the inertial navigation system, the control system further periodically controlling the standstill of the device, the acquisition on the spot of data relating to the position of the device by the satellite detection system and the correction of the position and advancing course of the device according to the data obtained by the satellite detection system.

31. The self-propelled robot device according to claim 30, wherein the central computing and controlling unit of the control system further comprises an algorithm for selecting on a statistical basis the data obtained by the satellite detection system according to the data previously obtained by the satellite detection system.

32. The self-propelled robot device according to claim 30, wherein the inertial navigation system of the control system comprises one or more among the sensors selected in the group comprising: odometers, gyroscopes, accelerometers, compasses.

33. The self-propelled robot device according to claim 30, wherein the satellite detection system of the control system comprises a GPS detector or a DGPS detector.

34. The self-propelled robot device according to claim 30, wherein the control system further comprises a proximity sensor suitable for detecting the presence of obstacles and the position thereof within the operating region of the self-propelled robot device.

35. The self-propelled robot device according to claim 30, wherein the self-propelled Robot device is a lawn-mowing robot device.
